(19) United States
(12) Patent Application Publication
(10) Pub. No.: US 2026/0196663 A1
(43) Pub. Date: Jul. 9, 2026

(54) SEPARATORS MODIFIED WITH CARBAZOLE FUNCTIONING POLYMERS

(71) Applicant: UCHICAGO ARGONNE, LLC, Chicago, IL (US)

(72) Inventors: Chen LIAO, Westmont, IL (US); Bingning WANG, Darien, IL (US); Lihong GAO, Chicago, IL (US)

(73) Assignee: UCHICAGO ARGONNE, LLC, Chicago, IL (US)

(21) Appl. No.: 19/014,777

(22) Filed: Jan. 9, 2025

(51) Int. Cl. H01M 50/417; H01M 4/02; H01M 4/505; H01M 4/525; H01M 10/0525; H01M 10/054; H01M 50/403; H01M 50/449; H01M 50/491

(52) U.S. Cl. CPC H01M 50/417; H01M 4/505; H01M 4/525; H01M 10/0525; H01M 10/054; H01M 50/403; H01M 50/449; H01M 50/491; H01M 2004/028

(57) ABSTRACT

A separator for a metal ion battery includes a layered polymer composite that itself includes a microporus polymer sheet of a polypropylene, polyethylene, a blend thereof, or 2 or more layers of polypropylene and/or polyethylene, where the microporus polymer sheet having a cathode-facing surface and an anode-facing surface, and where a second polymer layer is in contact with the cathode-facing surface of the microporus polymer sheet, and where the second polymer layer includes a carbazole group-containing polymer.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to separators for metal ion batteries. More specifically, it is related to layered separators containing polymers having carbazole functionality.

### SUMMARY

In one aspect, a separator for a metal ion battery is provided, where the separator includes a layered polymer composite, wherein the layered polymer composite includes a microporus polymer sheet comprising a polypropylene, polyethylene, a blend thereof, or 2 or more layers of polypropylene and/or polyethylene; the microporus polymer sheet having a cathode-facing surface and an anode-facing surface; a second polymer layer in contact with the cathode-facing surface of the microporus polymer sheet; the second polymer layer comprising a carbazole group-containing polymer. In some embodiments, the carbazole group-containing polymer may be a co-polymer of 9-phenyl-9H-carbazole-phenyl, poly(9-vinylcarbazole), or a blend thereof.

In another aspect, a metal ion battery includes a cathode, an anode, an electrolyte, and a separator including a layered polymer composite, the separator being disposed between the cathode and the anode, and where the layered polymer composite includes a microporus polymer sheet comprising a polypropylene, polyethylene, a blend thereof, or layers thereof, the microporus polymer sheet having a cathode-facing surface and an anode-facing surface, a second polymer layer in contact with the cathode-facing surface of the microporus polymer sheet, and the second polymer layer including a carbazole group-containing polymer. In various embodiments, the metal ion battery may be a lithium ion battery, a sodium ion battery, or a magnesium ion battery.

In a further aspect, a method of forming a separator for a metal ion battery includes providing a microporus polymer sheet comprising polypropylene, polyethylene, a blend thereof, or layers thereof, the microporous sheet having a first surface and an opposite facing second surface, applying a slurry comprising a solvent and a carbazole group-containing polymer to the first surface of the microporus polymer sheet, and removing the solvent to form the separator. In various embodiments, the carbazole group-containing polymer may include a co-polymer of 9-phenyl-9H-carbazole-phenyl, poly(9-vinylcarbazole), or a blend thereof.

### BRIEF DESCRIPTION OF THE DRAWINGS

FIGS. 1A-1D illustrate cycling specific capacities (FIG. 1A), capacity retentions (FIG. 1B), columbic efficiencies (FIG. 1C), and columbic efficiencies of the initial cycles (FIG. 1D) for LMR-NM∥Gr (0.3 Li₂MnO₃·0.7LiMn_{0.5}Ni_{0.5}O₂∥graphite) full cells using PCP coating modified Celgard 2325 separators with different coating thicknesses compared to the cell using baseline Celgard 2325 separator. The numbers of the initial columbic efficiencies for each cell are inserted in (d) as denoted.

FIGS. 2A-2F illustrate the differential capacity (dQ/dV) curves for the PCP 50 μm coated separator cell compared to the baseline cell: (FIG. 2A) cycle 1, the first formation cycle; (FIG. 2B) cycle 2, the second formation cycle; (FIG. 2C) cycle 4, the first activation cycle; (FIG. 2D) cycle 8, the first C/3 aging cycle; FIGS. 2E and 2F are area specific impedance (ASI) graphs for LMR-NM//Gr cell using different thicknesses PVC coating separators (50 μm (FIG. 2E) and 100 μm (FIG. 2F)) compared to a baseline cell using Celgard 2325.

FIGS. 3A-3B illustrate cyclic voltammetry curves of (FIG. 3A) PCP∥Li cell, and (FIG. 3B) PCP∥Cu cell compared to Al∥Cu, where the scan rate was 0.1 mV/s.

FIGS. 4A-4B illustrate the (FIG. 4A) C1s, F1s, O1s, and P2p regions of XPS spectra for the anodes collected from cycled PCP coating cell compared to the baseline, and (FIG. 4B) elements table for the anodes XPS spectra.

FIGS. 5A-5B illustrate the (FIG. 5A) C1s, F1s, Ols, and P2p regions of XPS spectra for the cathodes collected from cycled PCP coating cell compared to the baseline, and (FIG. 5B) elements table for the cathodes XPS spectra.

FIG. 6 illustrates an ICP-MS analysis of cycled anodes of PCP 100 μm coated separator, and Celgard 2325 baseline cells.

FIGS. 7A, 7B, and 7C illustrate the area specific impedance (ASI) for LMR-NM//Gr cell using different thicknesses PCP coating separators (50 μm (7A), 100 μm (7B), and 150 μm (7C)) compared to the baseline cell using Celgard 2325. The darker lines are the more aged cycles, and the initial and final ASI values are obtained at the lowest impedance points.

FIGS. 8A-8D are graphs of cycling specific capacities (FIG. 8A), capacity retention (FIG. 8B), columbic efficiency (FIG. 8C), and columbic efficiencies of the initial cycles (FIG. 8D) for LMR-NM∥Gr full cells using PVC coating modified Celgard 2325 separators with different coating thicknesses compared to the cell using baseline Celgard 2325 separator. The numbers of the initial columbic efficiencies for each cell are inserted in (FIG. 8D) as denoted.

FIGS. 9A and 9B illustrate the ASI for LMR-NM∥Gr cell using different thicknesses PVC coating separators (50 μm (9A) and 100 μm (9C)) compared to the baseline cell using Celgard 2325. The darker lines are the more aged cycles, and the initial and final ASI values are obtained at the lowest impedance points.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

It has now been found that carbazole functionalized polymers, such as a co-polymer of 9-phenyl-9H-carbazole-phenyl (PCP) and/or poly(9-vinylcarbazole) (PVC), each of a different structure, may be coated on commercial Celgard 2325 separators on the side facing cathode using a slurry coating method. As illustrated in Scheme 1, a PCP polymer has a polymer-phenyl-carbazole backbone ((a)), while the commercially available PVC comprises a polyethylene (PE) backbone with carbazole units as side chains ((b)). The modified separators enhance the cycling stability and columbic efficiency (CE) of LMR-NM//Gr full cells by effectively inhibiting cross-talk effect through reducing TM dissolution from the cathode.

Scheme 1: (a) Synthesis of copolymer of 9-phenyl-9H-carbazole-phenyl (PCP), and (b) molecular structure of poly(9-vinylcarbazole) (PVC).

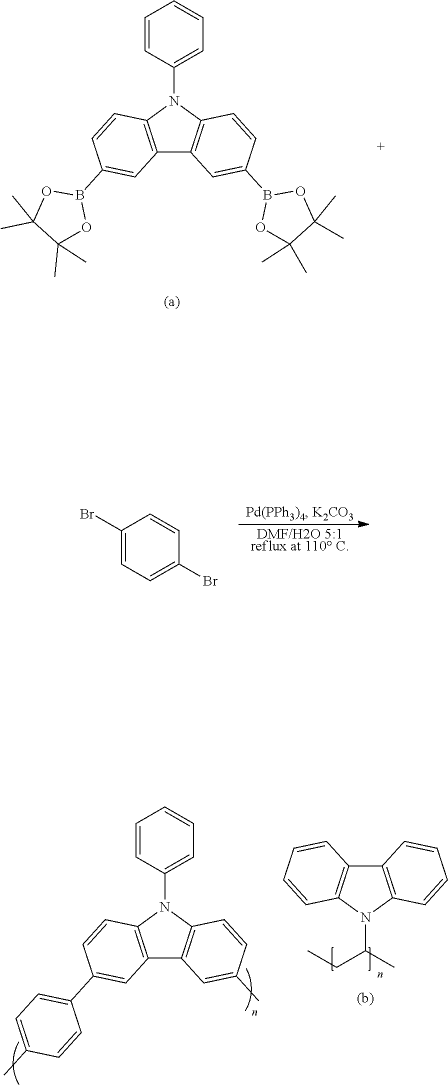

These improvements are attributed to the formation of higher-quality solid electrolyte interphases (SEI), as well as beneficial cathode electrolyte interphases (CEI) that are richer in lithium oxyfluorophosphates (LiₓPO_{y}F_{z}). The mechanism of interphase modifications is elucidated through dQ/dV analyses. During the first charging of LMR-NM//Gr full cells, irreversible polymer oxidation and anion insertion of hexfluorophosphate ions (PF₆⁻) occurs in the carbazole functionalized polymers, leading to the low initial Coulombic efficiency being observed, and the formation of advantageous interphases. Anion insertions take place at voltages of about 4.0 and about 3.5 V for PCP and PVC, respectively, and are highly irreversible according to cyclic voltammetry (CV) analyses. Furthermore, after the first charging, cathode-side voltages are maintained above 3.5 V in the full cells, higher than the voltages of potential PF₆⁻ extraction, ensuring that anion insertions occur only once during the initial charging without interfering with subsequent cells cycling.

However, the modified separators cause impedance increases in cell, particularly for the initial impedance. Simply coating polymers on separators can block the microporous structure, thereby impeding lithium ion transportation channels, and compromising the wetting capability of the separators, likely contributing to the high impedance. Although the impedance rise as cells aging is controlled with the modified separators, due to the alleviation of side reactions, the impedance issue is of a concern. PVC, a carbazole functionalized PE-based polymer, shows promising potential in addressing this challenge. Given that polypropylene (PP) and PE are the most commonly used materials in commercial LIB separators, integrating carbazole-functionalized PP or PE-based polymers like PVC holds great promise in modern separator manufacturing for enhancing cells cycling performance through interphase advancement without significant impedance rise. The relatively similar initial Coulombic Efficiencies (CEs) between the PVC modified cell and Celgard 2325 baseline cell suggest that a small amount of carbazole functional groups are sufficient for the formation of beneficial interphases, and the resulting performance improvement.

Provided herein is a separator for a metal ion battery. The separator(s) include a layered polymer composite that has a first polymer layer that is a microporus polymer sheet having a cathode-facing surface and an anode-facing surface. The microporous polymer sheet may be made of any porous, polymeric material known for use in batteries, including, but not limited to, polypropylene, polyethylene, a blend thereof, or 2 or more layers of polypropylene and/or polyethylene. The separator(s) also include a second polymer layer in contact with the cathode-facing surface of the microporus polymer sheet, wherein the second polymer layer includes a carbazole group-containing polymer.

The carbazole group-containing polymer may include where the carbazole is integrated as a group within the polymer backbone, i.e. backbone-carbazole-backbone-carbazole . . . , or where the polymer has a backbone from which carbazole groups are pendant. Both such structures are illustrated above in Scheme 1. In some embodiments, the carbazole group-containing polymer may be a co-polymer of 9-phenyl-9H-carbazole-phenyl, poly(9-vinylcarbazole), or a blend thereof.

In some embodiments, the microporous polymer sheet may include more than a single layer of polymer. For example, it may include two layers, or it may include three layers such that a core layer is sandwiched between a first outer layer and a second outer layer, or even more layers. In some embodiments, the microporous polymer sheet may include three layers such as a core layer including polyethylene and first and second outer layers each including polypropylene.

In another aspect, a metal ion battery is provided that includes a cathode, an anode, an electrolyte, and a separator disposed between the cathode and the anode, wherein the separator includes any of the layered polymer composites described herein having a first polymer layer that is a microporus polymer sheet having a cathode-facing surface and an anode-facing surface, and a second polymer layer in contact with the cathode-facing surface of the microporus polymer sheet, wherein the second polymer layer includes a carbazole group-containing polymer. The type of such a metal ion battery is entirely dependent upon the makeup of the cathode and anode, but it may be a lithium ion battery, a sodium ion battery, or a magnesium ion battery.

In the metal ion batteries, the cathode may include a cathode active material, a binder, and a current collector. In some embodiments, the cathode active material may include a lithium transition metal oxide, a sodium transition metal oxide, a potassium transition metal oxide, or a magnesium transition metal oxide. In various embodiments, illustrative cathode active materials include, but are not limited to, a spinel, an olivine, a surface modified olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}C_{γ}O₂, LiMn₂O₄, LiFeO₂, LiNi_{0.5}Me_{1.5}O₄, Li₁₊ₓ·NiₕMnₖCoₗMe²_{y}·O_{2-z}·F_{z′}, VO₂, Eₓ-F₂ (Me₃O₄)₃, or LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″≤3; with the proviso that at least one of h, k and l is greater than 0. The term “spinel” refers to a manganese-based spinel such as, Li₁₊ₓMn_{2-y}Me_{2-y}O₄₋ₕAₖ, wherein Me is Al, Mg, Ti, B, Ga, Si, Ni, or Co; A is S or F; and wherein 0≤x≤0.5, 0≤y≤0.5, 0≤z≤0.5, 0≤h≤0.5, and 0≤k≤0.5. The term “olivine” refers to an iron-based olivine such as, LiFe₁₋ₓMe_{z}O₄₋ₕAₖ, wherein Me is Al, Mg, Ti, B, Ga, Si, Ni, or Co; A is S or F; and wherein 0≤x≤0.5, 0≤y≤0.5, 0≤h≤0.5, and 0≤k≤0.5.

In various other embodiments, illustrative cathode active materials include, but are not limited to, NaFePO₄, NaCoO₂, NaNiO₂, NaMn₂O₄, or Na₁₋ₓNi_{α}Co_{β}Mn_{γ}M_{δ}O_{2-z}N_{z}, wherein M is Li, Al, Mg, Ti, B, Ga, Si, Zr, Zn, Cu, Fe; N is F, Cl, S; wherein 0≤x≤1, 0≤α≤1, 0≤β≤1, 0≤γ≤1, 0≤δ≤1, 0≤z≤2; with the proviso that at least one of α, β and γ is greater than 0. In some embodiments, the positive electrode includes Na_{1+W}MnₓNi_{y}Co₂O₂ wherein w, x, y, and z satisfy the relations 0≤w≤1, 0≤x<1, 0≤y<1, 0≤z<1, and x+y+z=1. In some embodiments, the cathode active material having a sodium ion may be intercalated with lithium. Other cathode materials may include those associated with potassium or magnesium batteries as well.

In yet other embodiments, the cathode active material may include LiMnₓNi_{y}O₄ wherein x and y satisfy 0≤x<2, 0≤y<2, and x+y=2; LiMnₓNi_{y}O₄ wherein x and y satisfy 0≤x<2, 0≤y<2, and x+y=2; xLi₂MnO₃·(1−x)LiMO₂ wherein 0≤x<2; Na_{w}MnₓNi_{y}CO₂O₂ wherein w, x, y, and z satisfy the relations 0<w<1.5, 0≤x<1, 0≤y<1, 0≤z<1, and x+y+z=1; or Na_{w}MeₓO₂ wherein Me is any transition metal and w and x satisfy the relations 0<w<1.5, 0≤x<1. In some embodiments, the cathode active material includes 0.3 Li₂MnO₃·0.7LiMn_{0.5}Ni_{0.5}O₂.

When used in the cathode, binders may be present in the anode and/or cathode in an amount of from about 0.1 wt % to about 99 wt %. In some embodiments, the binder is present in the electrode in an amount of from about 5 wt % to about 20 wt %. Illustrative binders include, but are not limited to, polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, sodium alginate, polythiophene, polyacetylene, poly(9,9-dioctylfluorene-co-fluorenone), poly(9,9-dioctylfluorene-co-fluorenone-co-methylbenzoic ester), a copolymer of any two or more such polymers, and a blend of any two or more such polymers. In some embodiments, the binder is an electrically conductive polymer such as, but not limited to, polythiophene, polyacetylene, poly(9,9-dioctylfluorene-co-fluorenone), poly(9,9-dioctylfluorene-co-fluorenone-co-methylbenzoic ester), and a copolymer of any two or more such conductive polymers.

The cathode may include a current collector, a porous carbon (e.g. conductive) material, and/or a polymeric binder. The current collector may include copper, stainless steel, titanium, tantalum, platinum, gold, aluminum, nickel, cobalt-nickel alloys, highly alloyed ferritic stainless steel containing molybdenum and chromium; or nickel-, chromium-, or molybdenum-containing alloys. The current collector may be a foil, mesh, or screen, and the porous carbon material and optional metal oxide are contacted with the current collector by casting, pressing, or rolling the mixture thereto.

The cathode may further include a porous carbon material. Illustrate porous carbon materials include, but are not limited to, natural graphite, synthetic graphite, hard carbon, amorphous carbon, soft carbon, mesocarbon microbeads (MCMB), acetylene black, Ketjen® black, carbon black, mesoporous carbon, porous carbon matrix, carbon nanotube, carbon nanofiber, and graphene.

In the metal ion batteries, the anode may include an anode active material, a binder, and a current collector. Illustrative anode active materials include, but are not limited to, natural graphite, synthetic graphite, hard carbon, amorphous carbon, soft carbon, mesocarbon microbeads (MCMB), acetylene black, Ketjen® black, carbon black, mesoporous carbon, porous carbon matrix, carbon nanotube, carbon nanofiber, graphene, silicon microparticle, silicon nanoparticle, silicon-carbon composite, tin microparticle, tin nanoparticle, tin-carbon composite, silicon-tin composite, phosphorous-carbon composites, black phosphorus, red phosphorus, mixture of red and black phosphorus, lithium titanium oxide, lithium metal, sodium metal, lithium titanium oxide, or magnesium metal. In some embodiments, the anode active material includes carbon nanotubes, carbon fiber, microporous carbon, mesoporous carbon, macroporous carbon, mesoporous microbeads, graphite, expandable graphite, polymer yield carbon, or carbon black, Li⁰, Sb⁰, Si⁰, Si—C, SiO, Sn⁰, tin oxide, Li₄Ti₅O₁₂, a composite tin alloy, a transition metal oxide, a lithium metal nitride, phosphorous, a phosphorous-carbon composite, or a mixture of any two or more thereof. In some embodiments, the anode includes lithium metal (i.e. Li⁰).

The anode may also include a current collector, a conductive carbon material, a binder, or any combination thereof. The anode current collector may be prepared from a wide variety of materials. For example, illustrative current collectors include, but are not limited to, carbon, copper, stainless steel, titanium, tantalum, platinum, palladium, gold, silver, iron, aluminum, nickel, rhodium, manganese, vanadium, titanium, tungsten, cobalt nickel alloy, highly alloyed ferritic stainless steel containing molybdenum and chromium; or nickel-, chromium-, or molybdenum-containing alloys, or a carbon-coated metal described above. The current collector may take the form of a foil, mesh, or screen. In some embodiments, the electroactive material disclosed herein and one or more of a conductive carbon material and a binder are contacted with the current collector by casting, pressing, or rolling the mixture thereto. In some embodiments, the current collector is copper, stainless steel, titanium, tantalum, platinum, gold, aluminum, nickel, cobalt, cobalt nickel alloy, highly alloyed ferritic stainless steel containing molybdenum and chromium, a nickel-containing alloy, a chromium-containing alloy, or a molybdenum-containing alloy.

The electrolyte of the metal ion battery may include a salt and an aprotic solvent. Illustrative solvents include, but are not limited to, ethylene carbonate, dimethylcarbonate, diethylcarbonate, propylene carbonate, fluoroethylene carbonate (FEC), ethyl methyl carbonate, dioloxane, γ-butyrolactone, δ-butyrolactone, dimethyl ether, a silane, siloxane N-methyl acetamide, acetonitrile, an acetal, a ketal, esters, a carbonates, a sulfone, a sulfite, sulfolane, an aliphatic ether, a cyclic ether, a glyme, a polyether, a phosphate ester, a siloxane, a n-alkylpyrrolidone, fluoro ether and fluoro esters, fluoroethylene carbonate, or adiponitrile. In some embodiments, the solvent includes trifluoroethyl methyl carbonate (FEMC), dimethoxyethane (DME), dimethyl carbonate (DMC), 1,3-dioxolane (DOL), ethylmethyl carbonate (EMC), diethyl carbonate (DEC), dimethyl sulfoxide (DMSO), ethyl vinyl sulfone (EVS), tetramethylene sulfone (TMS), ethyl methyl sulfone (EMS), ethylene carbonate (EC), vinylene carbonate (VC), fluoroethylene carbonate (FEC), difluoroethylene carbonate (DFEC), 4-vinyl-1,3-dioxolan-2-one (VEC), dimethyl sulfone, ethyl methyl sulfone, methyl butyrate, ethyl propionate, trimethyl phosphate, triethyl phosphate, gamma-butyrolactone, 4-methylene-1,3-dioxolan-2-one, methylene ethylene carbonate (MEC), 4,5-dimethylene-1,3-dioxolan-2-one, allyl ether, triallyl amine, triallyl cyanurate, triallylisocyanurate, water, or a combination of any two or more thereof. Of course, a mixture of any two or more such solvents may also be used. In some embodiments, the solvent is a mixture of solvents such as, but not limited to, FEC-DEC, FEC-EC-DEC, FEC-EMC, FEC-EC-EMC, EC-DMC, EC-DEC, EC-PC, EC-PC-DMC, EC-PC-DEC, or EC-DEC-DMC.

Suitable lithium salts for the electrolyte may include, but are not limited to, LiBF₂(C₂O₄); LiB(C₂O₄)₂; LiPF₂(C₂O₄)₂; LiPF₄(C²O₄); LiPF₆; lithium 4,5-dicyano-2-(trifluoromethyl)imidazole; lithium 4,5-dicyano-2-methylimidazole; trilithium 2,2′,2″-tris(trifluoromethyl)benzotris(imidazolate); LiN(CN) 2; lithium 4,5-dicyano-2-(trifluoromethyl)imidazole; lithium 4,5-dicyano-2-methylimidazole; trilithium 2,2′,2″-tris(trifluoromethyl)benzotris(imidazolate); Li(CF₃CO₂); Li(C₂F₅CO₂); LiCF₃SO₃; LiCH₃SO₃; LiN(SO₂CF₃)²; LiC(CF₃SO₂)₃; LiN(SO₂C₂F₅)₂; LiClO₄; LiBF₄; LiAsF₆; LiPF₆; LiPF₂ (C₂O₄)₂; LiPF₄(C₂O₄); LiB(C₂O₄)₂; LiBF₂ (C₂O₄)₂; Li₂ (B₁₂X₁₂₋ᵢHᵢ); Li₂ (B₁₀X₁₀₋ᵢHᵢ); and a mixture of any two or more thereof, wherein X is independently at each occurrence a halogen, i is an integer from 0 to 12 and i′ is an integer from 0 to 10. Similarly, the sodium, potassium, or magnesium versions of these same salts may be used where available and appropriate.

In any or all of the above embodiments, the electrolyte may include the salt at a concentration from about 0.1 M to about 10 M. This may include from about 0.1 M to about 8 M, from about 0.1 M to about 6 M, from about 0.1 M to about 5 M, from about 1 M to about 10 M, from about 1 M to about 8 M, from about 1 M to about 6 M, or from about 1 M to about 5 M. In embodiments where the electrolyte is a non-fluorinated solvent, the salt concentration may be larger, for example greater than 3 M. This includes from about 3 M to 10 M. In embodiments where the electrolyte includes a fluorinated solvent, the salt concentration may be from 0.1 M to 10 M, or any range as noted above. In embodiments where the electrolyte includes a mixture of a non-fluorinated carbonate and a fluorinated solvent, the salt concentration may be from 0.1 M to 10 M, or any range as noted above. In any or all of the above embodiments, the salt may include a lithium salt or a mixture of lithium salts, a sodium salt or a mixture of sodium salts, or a magnesium salt or a mixture of magnesium salts. In some embodiments, the salt comprises lithium bis(fluorosulfonyl)imide (LiFSI), lithium bis(trifluoromethylsulfonyl)imide (LiTFSI), sodium bis(fluorosulfonyl)imide (NaFSI), sodium bis(trifluoromethylsulfonyl)imide (NaTFSI), lithium bis(oxalato)borate (LiBOB), sodium bis(oxalato)borate (NaBOB), LiPFe, LiAsFe, LiN(SO₂CF₃)₂, LiN(SO₂F)₂, LiCF₃SO₃, LiClO₄, lithium difluoro oxalatoborate (LiDFOB), LiI, LiBr, LiCl, LiOH, LiNO₃, or any combination thereof. In certain of the foregoing embodiments, the salt is (i) LiFSI, LiTFSI, or a combination thereof, or (ii) NaFSI, NaTFSI, or a combination thereof; the solvent is DMC, DME, DOL, EMC, or a combination thereof; and the salt has a molar concentration in the electrolyte within a range of from 0.75 M to 1.5 M.

In some embodiments, the electrolyte may also contain an electrode stabilizing additive such as but is not limited to LiB(C₂O₄)₂, LiBF₂ (C₂O₄)₂, vinylene carbonate, vinyl ethylene carbonate, propargylmethyl carbonate, 1,3,2-dioxathiolane-2,2-dioxide, ethylene sulfite, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydrooyran, 3,9-diethylidene-2,4,8-trioxaspiro[5,5]undecane, 2-ethylidene-5-vinyl-[1,3]dioxane, anisoles, 2,5-dimethyl-1,4-dimethoxybenzene, 2,3,5,6-tetramethyl-1,4-dimethoxybenzene, 2,5-di-tert-butyl-1,4-dimethoxybenzene, or a mixture of two or more thereof. However, where the electrode stabilizing additive contains lithium, and when used, it is not the same as the lithium salt.

Fluorinated ethers may be included as the solvent. Fluroinated ethers may include one or more of 1,1,2,2-tetrafluoroethyl-2,2,2,3-tetrafluoropropyl ether (TTE), bis(2,2,2-trifluoroethyl) ether (BTFE), 1,1,2,2,-tetrafluoroethyl-2,2,2-trifluoroethyl ether (TFTFE), methoxynonafluorobutane (MOFB), and ethoxynonafluorobutane (EOFB).

In some embodiments, the electrolyte may also include a redox shuttle material. The shuttle, if present, will have an electrochemical potential above the positive electrode's maximum normal operating potential. Illustrative stabilizing agents include, but are not limited to, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydrooyran, 3,9-diethylidene-2,4,8-trioxaspiro[5,5]undecane, 2-ethylidene-5-vinyl-[1,3]dioxane, lithium alkyl fluorophosphates, lithium alkyl fluoroborates, lithium 4,5-dicyano-2-(trifluoromethyl)imidazole, lithium 4,5-dicyano-2-methylimidazole, trilithium 2,2′,2″-tris(trifluoromethyl)benzotris(imidazolate), Li(CF₃CO₂), Li(C₂F₅CO₂), LiCF₃SO₃, LiCH₃SO₃, LiN(SO₂CF₃)₂, LiC(CF₃SO₂)₃, LiN(SO₂C₂F₅)₂, LiClO₄, LiAsF₆, Li₂ (B₁₂X₁₂₋ᵢHᵢ), Li₂(B₁₀X_{10-I′}H_{i′}), wherein X is independently at each occurrence a halogen, I is an integer from 0 to 12 and I′ is an integer from 0 to 10, 1,3,2-dioxathiolane 2,2-dioxide, 4-methyl-1,3,2-dioxathiolane 2,2-dioxide, 4-(trifluoromethyl)-1,3,2-dioxathiolane 2,2-dioxide, 4-fluoro-1,3,2-dioxathiolane 2,2-dioxide, 4,5-difluoro-1,3,2-dioxathiolane 2,2-dioxide, dimethyl sulfate, methyl (2,2,2-trifluoroethyl) sulfate, methyl (trifluoromethyl) sulfate, bis(trifluoromethyl) sulfate, 1,2-oxathiolane 2,2-dioxide, methyl ethanesulfonate, 5-fluoro-1,2-oxathiolane 2,2-dioxide, 5-(trifluoromethyl)-1,2-oxathiolane 2,2-dioxide, 4-fluoro-1,2-oxathiolane 2,2-dioxide, 4-(trifluoromethyl)-1,2-oxathiolane 2,2-dioxide, 3-fluoro-1,2-oxathiolane 2,2-dioxide, 3-(trifluoromethyl)-1,2-oxathiolane 2,2-dioxide, difluoro-1,2-oxathiolane 2,2-dioxide, 5H-1,2-oxathiole 2,2-dioxide, 2,5-dimethyl-1,4-dimethoxybenzene, 2,3,5,6-tetramethyl-1,4-dimethoxybenzene, 2,5-di-tert-butyl-1,4-dimethoxybenzene or a mixture of any two or more thereof, with the proviso that when used, the redox shuttle is not the same as the lithium salt, even though they perform the same function in the cell. That is, for example, if the lithium salt is LiClO₄, it may also perform the dual function of being a redox shuttle, however if a redox shuttle is included in that same cell, it will be a different material than LiClO₄.

In a further aspect, a method of forming a separator for a metal ion battery is provided. The method includes providing a microporous polymer sheet comprising polypropylene, polyethylene, a blend thereof, or layers thereof, where the microporous sheet having a first surface and an opposite facing second surface. To the first surface of the microporus polymer sheet is applied a slurry comprising a solvent and a carbazole group-containing polymer. The solvent is then removed from the slurry to form the separator with the carbazole group-containing polymer formed as a layer on the microporous sheet. In some embodiments, the carbazole group-containing polymer is any as described herein including a co-polymer of 9-phenyl-9H-carbazole-phenyl, poly(9-vinylcarbazole), or a blend thereof.

The slurry may further include any of the binders that are described for any of the cathodes or anodes, where the binder with the carbazole group-containing polymer serves to assist in affixing it to the microporous polymer sheet. In some embodiments, the slurry includes polyvinylidenedifluoride as the binder.

The solvent for the slurry is a solvent in which the carbazole group-containing polymer is suspendable or dissolvable. Illustrated solvents include, but are not limited to N-methylpyrrolidone, carbonates, nitriles, dimethylacetamide, acetone, and alcohols such as methanol, ethanol, and isopropanol.

The present invention, thus generally described, will be understood more readily by reference to the following examples, which are provided by way of illustration and are not intended to be limiting of the present invention.

### EXAMPLES

Example 1. Synthesis of PCP (co-polymer of 9-phenyl-9H-carbazole-phenyl). PCP was synthesized by Suzuki coupling with 1 mmol 9-Phenyl-3,6-bis(4,4,5,5-tetramethyl-1,3,2-dioxaborolan-2-yl)-9H-carbazole (TCI America), 1 mmol 1,4-dibromobenzene (Sigma-Aldrich), 6 mmol K₂CO₃ (Sigma-Aldrich) and 0.1 mmol Pd(PPh₃)₄ (Sigma-Aldrich) in a two-neck round bottom flask with 50 ml solvent of dimethylformamide/deionized water in a volume ratio of 5:1. The reactants were then subjected to reflux with stirring for 72 hours at 110° C. under protection of N₂. After completion, the mixture was filtered to remove the solvent. The collected solids were then poured into dimethylformamide, and washed at 50° C. overnight to remove the reactant residues. After filtration, the collected solids were further washed with deionized water, and dried under vacuum at 60° C.

Example 2. Separator Coating. The carbazole functionalized polymers and polyvinylidenedifluoride (PVDF) were well mixed to form a uniform slurry in the ratio of 7:3 with NMP, where the PVDF is in the form of 8 wt. % PVDF NMP solutions. The slurry is then coated onto a Celgard 2325 separator manually using a doctor blade (with thicknesses of 50, 100, or 150 μm). The separators were dried in a vacuum oven overnight at 45° C. to remove NMP, cut into 16 mm diameter pieces, and then further vacuum dried in an Ar-filled glovebox at 45° C. before use.

Example 3. Electrochemical Test. Cycling tests of cells formed with the coated separators from Example 2, were performed in full cells of LMR-NM//Gr with 20 μl Gen2 electrolyte (3:7 ethylene carbonate: diethylcarbonate) at room temperature. Un-coated Celgard 2325 separators were used as the control, or baseline. The test protocol included three formation cycles at a C/10 rate (1 C=2.8 mA) with a voltage window of 2.5-4.3 V, followed by two activation cycles at C/20 with a voltage window of 2.5-4.6 V and 80 aging cycles at C/3 with a voltage window of 2.5-4.4 V. Immediately before and after every 20 aging cycles, the cell performance is measured with a slow C/25 cycle with a voltage window of 2.5-4.4 V to test its true capacity, a fast 1 C cycle with a voltage window of 2.5-4.4 V to test its cycling performance at high rate, and a modified hybrid pulse power characterization (HPPC) sequence to exam its impedance.

Cyclic voltammetry measurements were conducted at a scan rate of 0.1 mV/s for PCP//Li cell with a voltage window of 1-5 V, and for PCP//Cu and Al//Cu cells between a voltage window of 0-5 V. The PCP electrodes comprise of 70 wt. % PCP and 30 wt. % PVDF, coated on aluminum (“Al”) foil via slurry coating.

Example 4. Characterization by X-ray Photoelectron Spectra (“XPS”). XPS was performed using a PHI 5000 VersaProbe II System (Physical Electronics) with a base pressure of 2×10⁻⁹ Torr. The cycled anodes and cathodes were harvested from the aged cells and washed with dimethyl carbonate (“DMC”) prior to measurement. The photoelectron spectra were obtained in the fixed analyzer transmission mode using an Al Kα radiation (hν=1486.6 eV, 100 μm beam, 25 W) with Ar⁺ and electron beam sample neutralization. XPS spectra were aligned to the graphitic carbon at 284.5 eV.

Example 5. Characterization by Fourier-transform Spectroscopy (FT-IR). The reactants of 9-Phenyl-3,6-bis(4,4,5,5-tetramethyl-1,3,2-dioxaborolan-2-yl)-9H-carbazole and 1,4-dibromobenzene, and the synthesized product of PCP were subjected to FT-IR characterization using a Thermo Scientific Nicolet iS5 FT-IR Spectrometer over a range of 500 to 4000 cm⁻¹. Disappearance of the B—O (1346.55 cm⁻¹) and C—Br (10⁶⁴ cm⁻¹) FT-IR stretches in the synthesized PCP confirmed its successful synthesis.

Example 6. Characterization by Inductively Coupled Plasma-Mass Spectra (“ICP-MS”). To quantitatively evaluate transition metal dissolution in the aged cells, the cycled anodes were rinsed with DMC, transferred to a quartz beaker, and heated in a furnace at 700° C. for 12 hours. The resulting ash was refluxed with a mixture of nitric and hydrochloric acids at 220° C. for 1 h, and the solutions were then diluted with water. The samples were analyzed using ICP-MS to determine the transition metal concentrations that were referenced to the weight of the anode. Measurements were made using a PerkinElmer NexION 2000 ICP Mass Spectrometer calibrated with the NIST traceable standards.

Example 7. Nuclear Magnetic Resonance (NMR) Spectroscopy. To test the solubility of the carbazole polymers in Gen2 electrolyte, specific amounts of PCP and PVC were dispersed in Gen2 and stirred vigorously for 2 days, respectively. After stirring, the electrolytes were filtered with a 0.22 μm pore size syringe, and then injected into NMR tubes. Fluorinated ethylene propylene (FEP) NMR tube liners filled with benzene-de were included in the NMR tubes as a reference. The Gen2 electrolytes were then subjected to 1H NMR analyses to check if any PCP or PVC had dissolved.

To verify the oxidation of PCP, a PCP//Li half-cell was assembled, charged to 5 V with a current of 10 μA, and then disassembled. The PCP electrode was subsequently immersed in dimethyl sulfoxide-d₆ (DMSO-d₆), which dissolved easily due to the increased polarization caused by oxidation of PCP. The resulting solution was then transferred into an NMR tube. A fluorinated ethylene propylene (FEP) NMR tube liner filled with LiPF₆ DMSO-d₆ solution was also included as a reference. The solution was then subjected to ¹⁹F and ³¹P NMR analyses. For comparison, PCP polymers were also dispersed in DMSO-d₆, and sonicated for 2 hours, but no dissolution was observed.

Example 8. Electrolyte Uptake. Separators were weighed before and after being totally immersed into Gen2 electrolyte. After complete wetting, excess electrolyte attached to the separator surfaces was removed by filter papers. The electrolyte uptake for each separator was then calculated by the equation:

$$Electrolyte uptake = ( {W}_{wet} - {W}_{d r y} ) / {W}_{dry} * 100 \% , \qquad ( Eq . )$$

where W_{dry} and W_{wet} are the weights of separators before and after wetting by Gen2, respectively. Table 1 shows the electrolyte uptake amounts and percentages.

TABLE 1
Electrolyte uptake of different separators calculated
by immersing separators into Gen2 electrolyte.

| | Wt. before | Wt. after | Electrolyte |
|---|---|---|---|
| | immersion | immersion | Uptake |
| | in Gen2 (mg) | in Gen2 (mg) | (%) |
| Celgard 2325 | 2.00 | 5.24 | 75.25 |
| Celgard 2325_PCP | 3.47 | 5.28 | 52.16 |
| 50 μm coating | | | |
| Celgard 2325_PCP | 4.04 | 5.89 | 45.79 |
| 100 μm coating | | | |
| Celgard 2325_PVC | 3.87 | 5.43 | 40.31 |
| 50 μm coating | | | |
| Celgard 2325_PVC | 4.74 | 6.10 | 28.69 |
| 50 μm coating | | | |

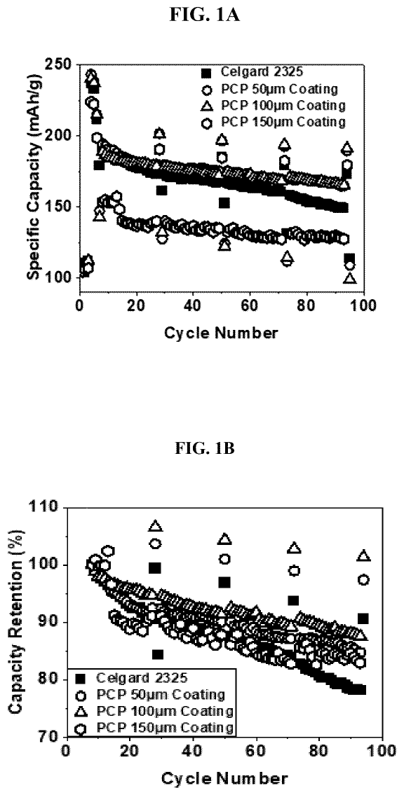

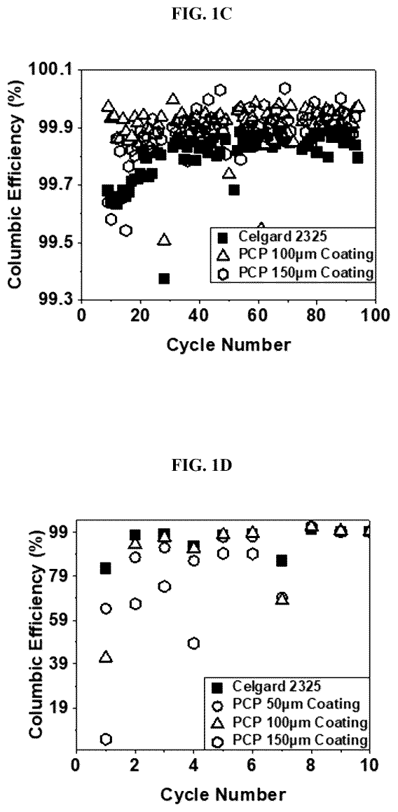

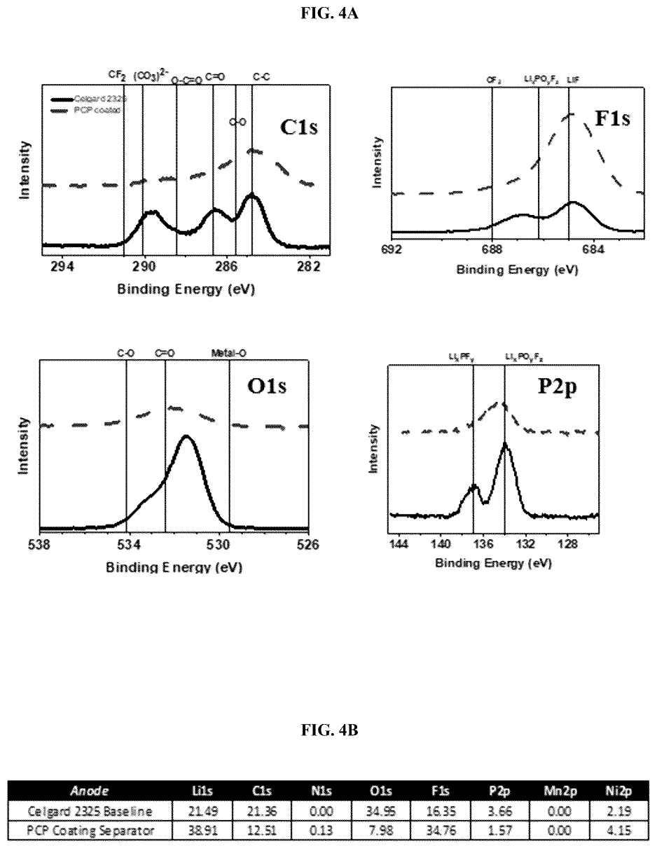

Example 9. Results and Discussion. PCP was synthesized via Suzuki coupling, as presented in Scheme 1a, and applied to modify Celgard 2325 separators using the slurry coating method on the side facing cathode, with thicknesses of 50, 100, and 150 μm, respectively. The performance of the modified separators was evaluated using LMR-NM//Gr full cells, with cycling results of specific capacities, capacity retentions, and CEs presented in FIGS. 1A, 1B, 1C, and 1D. Separators with 50 and 100 μm PCP coating exhibited improved cycling performance compared to Celgard 2325 baseline (see FIG. 1A), particularly evident for the C/20 show cycles. However, the separator with a 150 μm coating, though showing a stable cycling trend after about 10 cycles, displayed decreased cycling specific capacities due to excessive coating. As depicted in FIG. 1B, PCP modifications improved the cells capacity retention of the C/3 aging cycles from 78.13% of the baseline cell to 84.72%, 87.48%, and 82.94% for coating thicknesses of 50, 100, and 150 μm, respectively, highlighting the remarkable benefits of PCP modifications in enhancing cells cycling stability. Additionally, PCP modifications improved the cells CEs (see FIG. 1C), indicating that side reactions were suppressed. Most notably, the 100 μm coating demonstrated an average CE of 99.92%, significantly higher than the baseline cell's 99.81%. Interestingly, as presented in FIG. 4D, the initial CEs of the PCP-coated cells were unusually low, and decreased with increasing coating thickness. However, the dramatic differences gradually disappeared over cycling without interfering with the electrochemical performances in subsequent cycles.

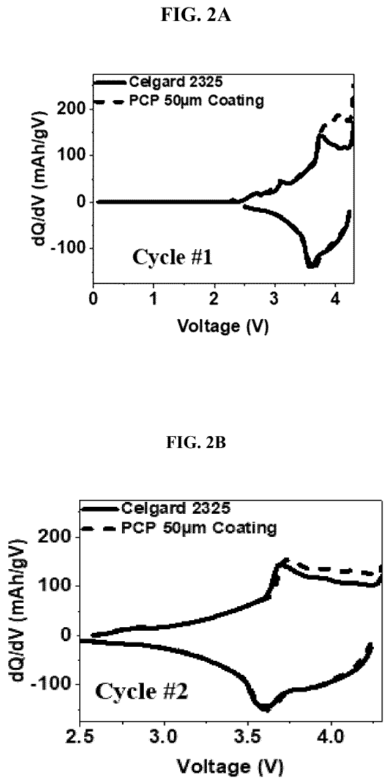

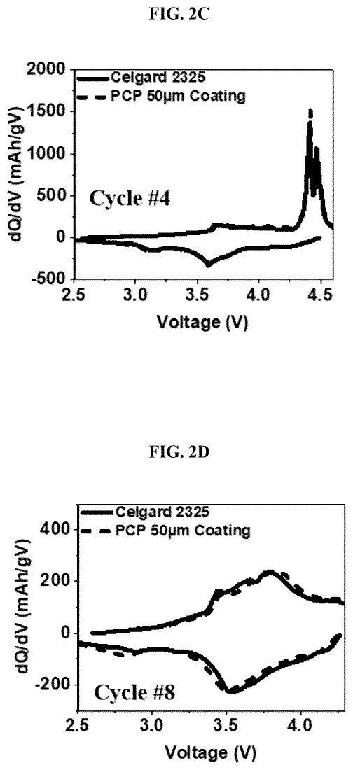

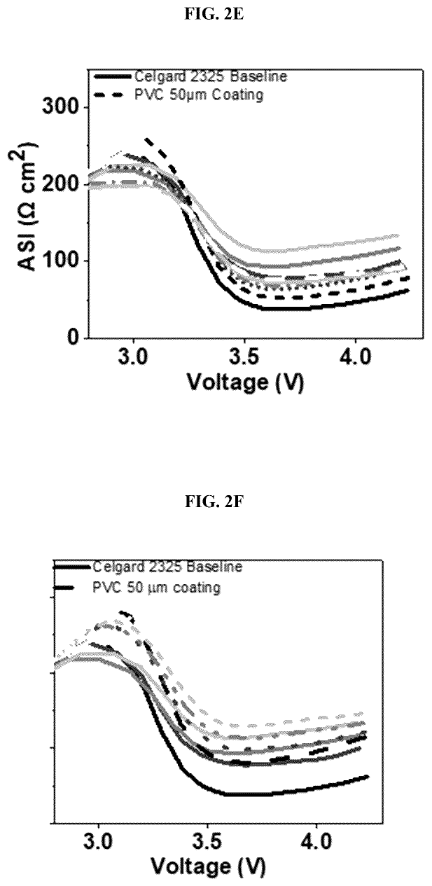

To investigate the underlying reason, dQ/dV analyses were conducted. The dQ/dV curves of cycle #1 (the first formation cycle), cycle #2 (the second formation cycle), cycle #4 (the first activation cycle), and cycle #9 (the first C/3 aging cycle) for each modified cell, compared to the non-modified baseline were presented in FIGS. 2A, 2B, 2C, and 2D. For the 50 and 100 μm coating cells, during the first charging, two additional peaks at about 2.3 and about 4.0 V were observed. While in the subsequent discharging process and following cycles, the dQ/dV profiles matched well with the baseline without additional peaks. The intensity of the additional peak at 4.0 V in the first charging cycle also increased with the PCP coating amounts, indicating a direct relationship between PCP coating and the additional reactions, which may be the reason for the observed improvement in electrochemical performance. When the coating thickness was increased to 150 μm, an additional peak at about 4.0 V in the 1st charging was extremely high, and still noticeable in cycle 2 and 4 due to the excessive PCP coating. However, no extra peaks were present in any discharging processes, and cycle 9.

Recent developments in anion batteries and dual-ion batteries, through the storage of anions, are regarded as promising alternatives for present metal ion batteries. The hexafluorophosphate ion (PF₆⁻) may intercalate into graphite forming graphite intercalation compounds at high potentials. Similarly, organic materials such as diamino-rubicene, dinitrobenzene, and the like were designed as cathode materials owing to their capability of being oxidized and intercalated by anions at high voltages. Noteworthily, the anion assertion of PF₆⁻ into PCP occurred at the voltage about 4.0 V, and its reversible process, if any, would happen at a low voltage. However, after the first charging process, the voltage of the cathode side would be maintained above 3.5 V in the full cell, thus keeping PCP in its oxidized state, and ensuring the irreversibility of the anion insertion.

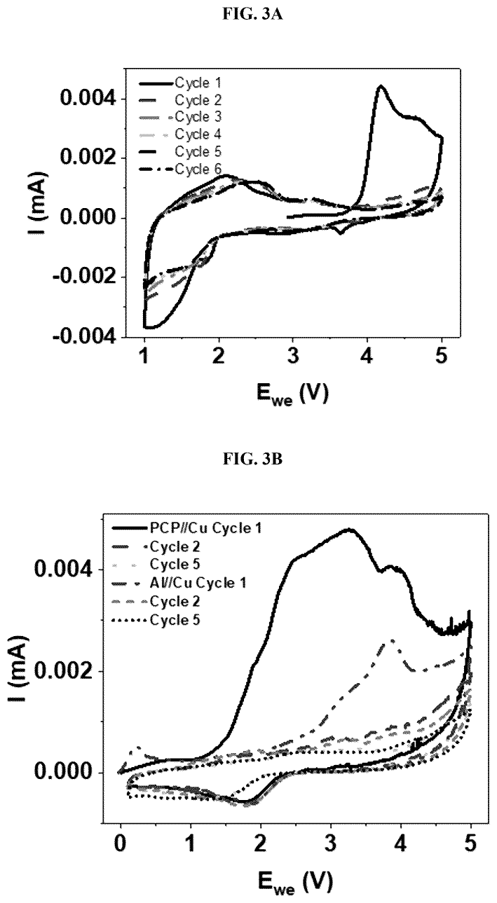

Cyclic voltammetry (CV) analyses were conducted to confirm the anion insertion of PCP. FIG. 3A presents the CV curves of PCP//Li half-cell. An oxidation peak at about 4.1 V was observed in the first cycle, corresponding to additional 4.0 V peak observed in the previous dQ/dV curves, implying the PF₆⁻ anion insertion into PCP. Though two weak reduction peaks were observed at 3.6 and 1.8 V, no oxidation or reduction peaks were present in the subsequent scans, indicating the reversibility of PF₆⁻ anion insertion into PCP was very limited, further confirming that the PF₆⁻ intercalated PCP would remain electrochemically inert after the first charging. FIG. 3B presents the CV curves of PCP//Cu compared to Al//Cu cell. When PCP was coated on the A1 current collector, an additional dramatic oxidation shoulder was observed, also supporting the anion insertion process of PCP.

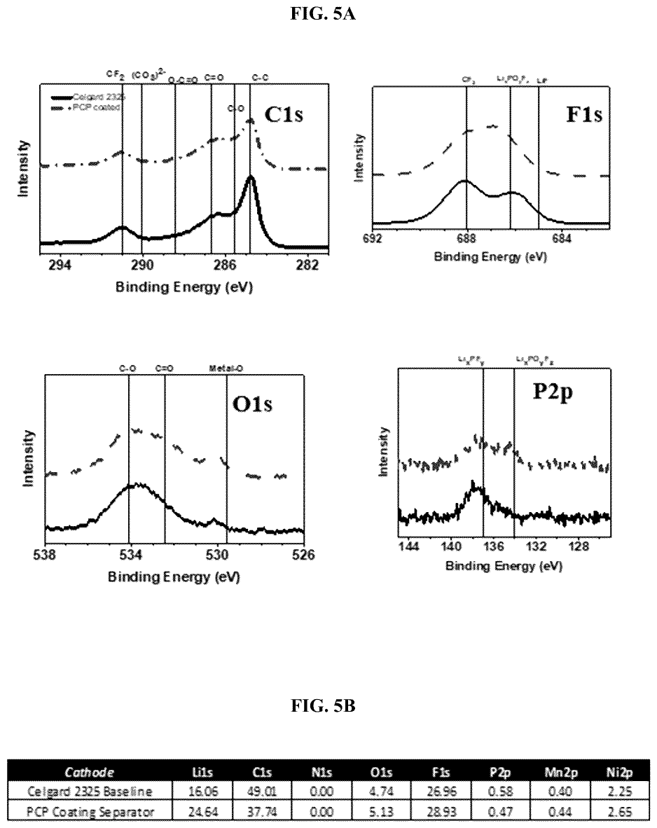

To elucidate the mechanism behind the enhanced cycling performance resulting from PCP coated separator, XPS measurements were performed on the collected anodes and cathodes after cycling. FIG. 4A shows the C1s, F1s, O1s, and P2p regions of XPS spectra for the cycled anodes collected from the PCP coating cell and the baseline. The SEI of PCP-modified cell exhibited more inorganic LiF and less organic (CO₃)²⁻ and C═O in F1s and C1s regions, respectively. The P2p region also showed obvious differences, and N signals were detected for the PCP coating cell, probably due to polymers dissolution during long-time cycling. The atomic concentrations from anode XPS measurements were presented in FIG. 4B, with results consistent with the conclusions from the spectra. Li and F dominated the SEI surface of PCP coating cell, while Li, C and O were the main compositions for the baseline, further confirming that PCP coating significantly modified the SEI to be more inorganic, which is widely reported to be beneficial for the electrochemical performance of LIBs. The cathode electrolyte interface (“CEI”) compositions were also examined by XPS, with results presented in FIG. 5. The F1s and P2p spectra showed the most significant differences, revealing that the CEI of PCP coating cell was richer in LiₓPO_{y}F_{z}, which is well acknowledged as beneficial in CEI components.

Based on the dQ/dV analyses and XPS results, it can be concluded that via the oxidation and anion insertion process, PCP participated in the electrolyte decompositions for interphases formation, driving the establishment of beneficial interphases on both anode and cathode sides, and resulting in the improved cycling performance of LMR-NM//Gr full cells. In addition, the charged PCP layer on the separator may also facilitate Li+ transportation into electrodes due to electrostatic repulsion.

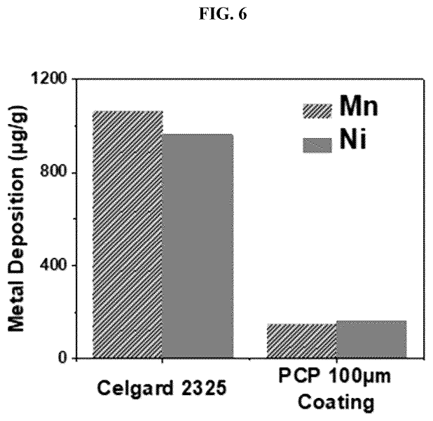

Because the PCP 100 μm coated cell presented the highest CE, indicating fewer side reactions during cycling, ICP-MS measurements were conducted for its cycled anode compared to non-modified Celgard 2325 baseline to examine the effect of PCP-driven interphases on transition metal (TM) dissolution. As presented in FIG. 6, TM dissolutions were significantly mitigated for the PCP modified cell, with Mn dissolution decreasing from 1063.64 μg/g in the baseline cell to 148.63 μg/g. The mitigated TM dissolutions can notably alleviate cross-talk effect, which is a notorious culprit for cells degradation, owing to the interphases advancement caused by the oxidation and anion insertion process of PCP during the 1^{st} charging.

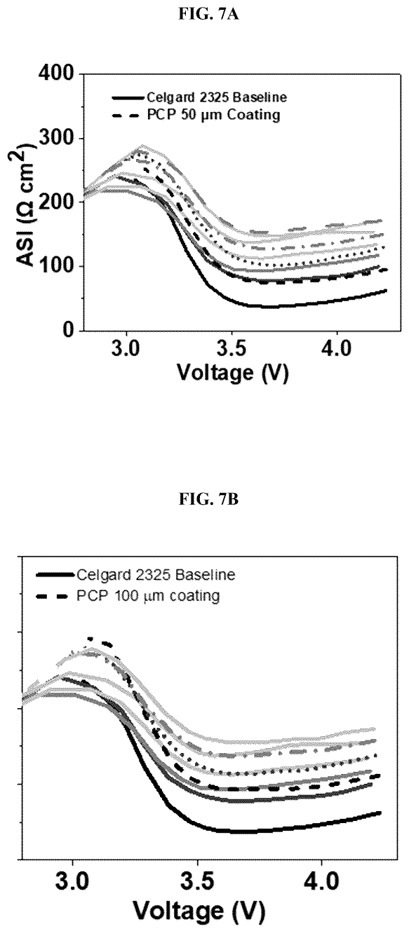

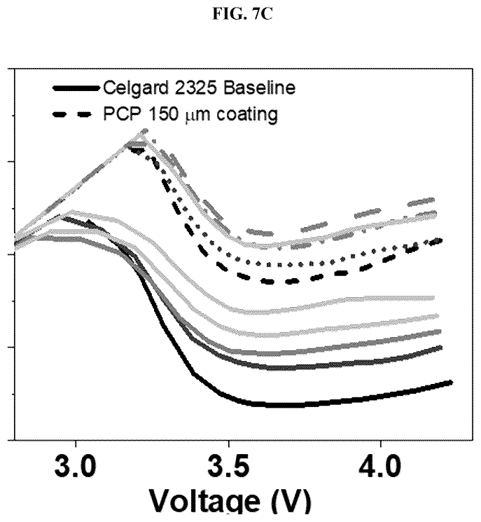

Although PCP coated separators demonstrated impressive improvements in cycling stability, CE, and TM dissolution suppression, the impedance of PCP modified cell, particularly the initial impedance, noticeably increased, with ASI results presented in FIG. 7. The 50, 100, and 150 μm PCP coating substantially raised the ASI from 37.63 Ω cm² of baseline cell to 74.37, 92.84, and 170.97 Ω cm², respectively (See Tables 2 and 3). Though the percentage increases in impedance were suppressed due to mitigated side reactions, the impedance performance of the PCP coated cells remained unsatisfactory. The impedance rise is ascribed to the simple slurry coating method employed. The coating layer would block the micropores of the separator, thereby impeding lithium ion transportation channels and comprising the wetting capability of the separator, leading to higher impedances. Advancing separator manufacturing methods for PCP modification and/or applying other carbazole based polymers may offer solutions to address this issue.

TABLE 2
The initial, final, and increase percentages of ASI values
for each PCP cell and the baseline. The initial and final
ASI values are obtained at the lowest impedance points.

| | Celgard | | | |
|---|---|---|---|---|
| ASI Impedance | 2325 | PCP 50 μm | PCP 100 μm | PCP 150 μm |
| (Ω cm²) | baseline | Coating | Coating | Coating |
| Initial | 37.63 | 74.37 | 92.84 | 170.97 |
| Final | 137.38 | 153.5 | 174.23 | 222.37 |
| % Increase | 265.08 | 106.48 | 87.67 | 30.01 |

TABLE 3
The initial, final, and increase percentages of ASI values
for each PVC cell and the baseline. The initial and final
ASI values are obtained at the lowest impedance points.

| ASI Impedance | Celgard 2325 | PCP 50 μm | PCP 100 μm |
|---|---|---|---|
| (Ω cm²) | baseline | Coating | Coating |
| Initial | 37.63 | 52.53 | 80.87 |
| Final | 137.38 | 76.36 | 143.66 |
| % Increase | 265.08 | 45.36 | 77.64 |

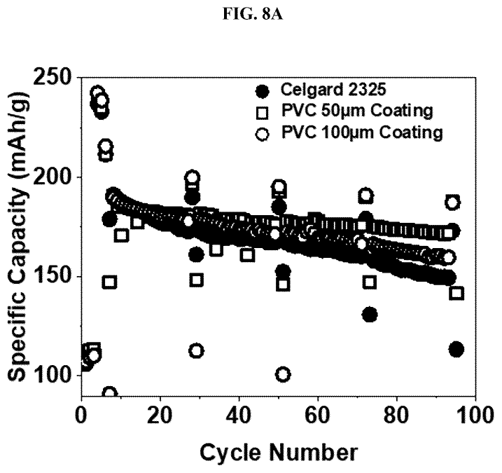

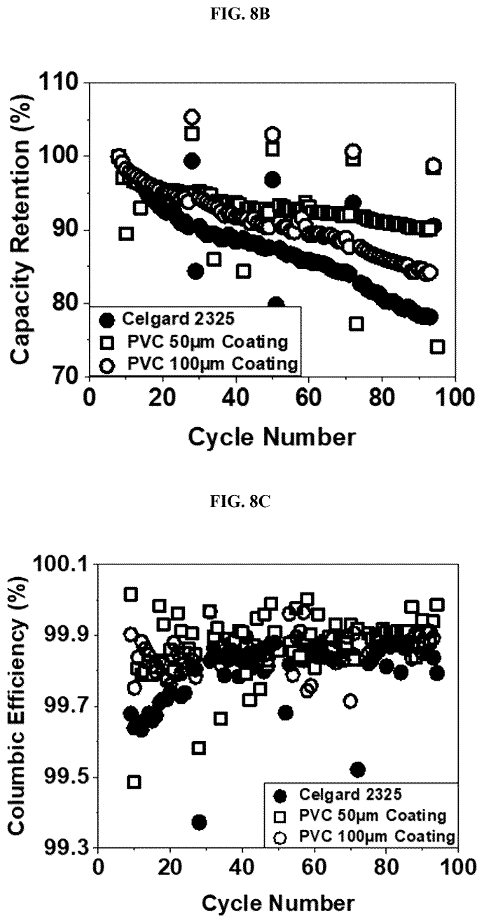

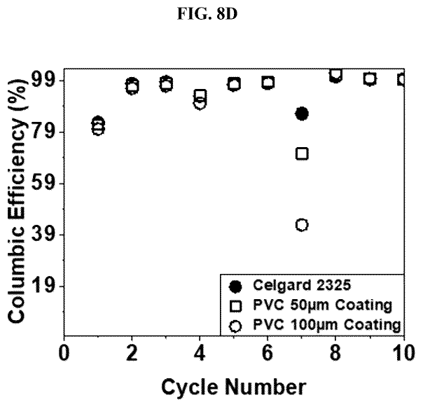

PVC, a commercially available polymer with carbazole functionality and a PE backbone, was examined for its capability to improve cells performance using the same coating method at different thicknesses. The electrochemical cycling results are presented in FIG. 8. 50 and 100 μm coating thicknesses were applied for PVC, as a 150 μm coating would lead to cells failure at initial cycles in our testing. Improved cycling specific capacities, cycling retentions, and CEs were observed for LMR-NM//Gr full cells using the PVC coated separators. Particularly for the 50 μm coating, the capacity retention and averaged CE of the C/3 aging cycles increased from 78.13% and 99.81% of the baseline cell to 90.14% and 99.88%, respectively. As for the initial CEs presented in FIG. 8d, though they decreased with thicker PVC coating, unlike the PCP modified samples, the initial CEs of PVC coated cells were only slightly lower than the Celgard 2325 baseline. This suggests an enhanced compatibility and alleviated anion insertion process for PVC compared to PCP.

Similar to PCP, additional peaks at about 2.3 V and about 3.5 V were observed for the PVC-modified cells in the first charging process, indicating that the anion insertion of PF₆⁻ is a common feature for carbazole functional groups at high voltages. The improved cycling performance may be ascribed to the interphase modification accompanying the oxidation and anion insertion process of carbazole functionalized polymers.

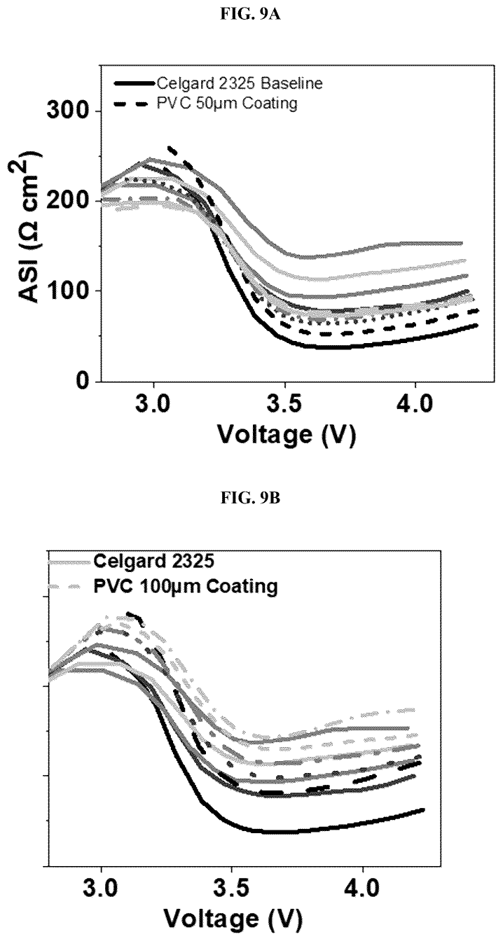

FIG. 9 is a presentation of the ASI results for the PVC modified cells compared to baseline. Similarly, PVC coating significantly increased the initial impedances. While for the PVC 50 μm coating, the final impedance decreased to 76.36 Ω cm², with only a 45.36% increase, much lower than the baseline and PCP coating cells. The controlled impedance rise may be attributed to effectively mitigated side reactions due to the PVC induced interphases modification and better wetting compatibility between PVC and electrolyte compared to PCP.

When PCP was coated on the Celgard 2325 separator with appropriate thicknesses, improved cycling stability were observed for LMR-NM//Gr full cells, along with enhanced CEs, and mitigated TM dissolutions. However, the slurry coating method led to a increase in impedance, especially the initial impedance. Notably, the initial CEs of the carbazole polymer coated separators cells were remarkably low, and decreased with increasing coating thickness. Through dQ/dV analysis, it was found that carbazole functionalized polymers undergo oxidation and PF₆⁻ anion insertion during the first charging, which was irreversible without participating in subsequent electrochemical reactions. From the XPS measurements, a more inorganic SEI and a CEI richer in LiₓPO_{y}F_{z} were observed for the PCP modified cell, indicating beneficial interphases were formed owing to the oxidation and anion insertion process. The enhanced cycling performance of LMR-NM//Gr full cells may be ascribed to the establishment of the higher quality interphases.

PVC, another carbazole functioning, PE-based, and commercially available polymer, was also applied for separator modification, improving cycling retention, and showing similar additional peaks only in the first charging. Therefore, the carbazole functionalization can be considered as a universal and promising method in separator modifications. The relatively close initial CEs of the PVC modified cells to the baseline also indicate that the significant cycling improvement can be achieved with small amounts of carbazole functional groups. It is believed that the PE-based polymer PVC can be easily integrated into advancing separator manufacturing technologies to address this issue.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A separator for a metal ion battery, the separator comprising a layered polymer composite,
wherein the layered polymer composite comprises:
a microporus polymer sheet comprising a polypropylene, polyethylene, a blend thereof, or 2 or more layers of polypropylene and/or polyethylene;
the microporus polymer sheet having a cathode-facing surface and an anode-facing surface;
a second polymer layer in contact with the cathode-facing surface of the microporus polymer sheet;
the second polymer layer comprising a carbazole group-containing polymer.

2. The separator of claim 1, wherein the carbazole group-containing polymer comprises a co-polymer of 9-phenyl-9H-carbazole-phenyl, poly(9-vinylcarbazole), or a blend thereof.

3. The separator of claim 1, wherein the microporous polymer sheet comprises a core layer between a first and second outer layers, wherein the core layer comprises polyethylene and the first and second outer layers comprise polypropylene.

4. A metal ion battery comprising:
a cathode;
an anode;
an electrolyte; and
a separator comprising a layered polymer composite, the separator being disposed between the cathode and the anode;
wherein:
the layered polymer composite comprises:
a microporus polymer sheet comprising a polypropylene, polyethylene, a blend thereof, or layers thereof;
the microporus polymer sheet having a cathode-facing surface and an anode-facing surface;
a second polymer layer in contact with the cathode-facing surface of the microporus polymer sheet;
the second polymer layer comprising a carbazole group-containing polymer.

5. The metal ion battery of claim 4 which is a lithium ion battery, a sodium ion battery, or a magnesium ion battery.

6. The metal ion battery of claim 5, wherein the cathode comprises a cathode active material, a binder, and a current collector.

7. The metal ion battery of claim 6, wherein the cathode active material comprises a lithium transition metal oxide or a sodium transition metal oxide.

8. The metal ion battery of claim 6, wherein the cathode active material comprises a spinel, an olivine, a surface modified olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCoₗMe²_{y}·O_{2-z}F_{z′}, VO₂, E_{x″}F₂(Me₃O₄)₃, or LiNiₘMnₙO₄, wherein Me is Al, Mg, Ti, B, Ga, Si, Mn, or Co; Me₂ is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″≤3; with the proviso that at least one of h, k and l is greater than 0.

9. The metal ion battery of claim 6, wherein the cathode active material comprises a layered structure, a spinel, a olivine with and without coating material that includes, but is not limited to carbon, polymer, fluorine, metal oxides, NaFePO₄, NaCoO₂, NaNiO₂, NaMn₂O₄, or Na₁₋ₓNi_{α}Co_{β}Mn_{γ}M_{δ}O_{2-z}N_{z}, wherein M is Li, Al, Mg, Ti, B, Ga, Si, Zr, Zn, Cu, Fe; N is F, Cl, S; wherein 0≤x≤1, 0≤α≤1, 0≤β≤1, 0≤γ≤1, 0≤δ≤1, 0≤z≤2; with the proviso that at least one of α, β and γ is greater than 0.

10. The metal ion battery of claim 6, wherein the cathode active material comprises LiMnₓNi_{y}O₄ wherein x and y satisfy 0≤x<2, 0≤y<2, and x+y=2; LiMnₓNi_{y}O₄ wherein x and y satisfy 0≤x<2, 0≤y<2, and x+y=2; xLi₂MnO₃·(1−x)LiMO₂ wherein 0≤x<2; Na_{w}MnₓNi_{y}CO₂O₂ wherein w, x, y, and z satisfy the relations 0<w<1.5, 0≤x≤1, 0≤y≤1, 0≤z≤1, and x+y+z=1; or Na_{w}MeₓO₂ wherein Me is any transition metal and w and x satisfy the relations 0<w<1.5, 0≤x<1.

11. The metal ion battery of claim 4, wherein the cathode comprises 0.3 Li₂MnO₃·0.7LiMn_{0.5}Ni_{0.5}O₂.

12. The metal ion battery of claim 4, wherein the anode comprises an anode active material, a binder, and a current collector.

13. The metal ion battery of claim 12, wherein the anode comprises natural graphite, synthetic graphite, hard carbon, amorphous carbon, soft carbon, mesocarbon microbeads (MCMB), acetylene black, Ketjen® black, carbon black, mesoporous carbon, porous carbon matrix, carbon nanotube, carbon nanofiber, graphene, silicon microparticle, silicon nanoparticle, silicon-carbon composite, tin microparticle, tin nanoparticle, tin-carbon composite, silicon-tin composite, phosphorous-carbon composites, black phosphorus, red phosphorus, mixture of red and black phosphorus, lithium titanium oxide, lithium metal, sodium metal, lithium titanium oxide, or magnesium metal.

14. The metal ion battery of claim 4, wherein the electrolyte comprises a lithium salt and a solvent.

15. The metal ion battery of claim 4, wherein the microporous polymer sheet comprises a core layer between a first and second outer layers, wherein the core layer comprises polyethylene and the first and second outer layers comprise polypropylene.

16. The metal ion battery of claim 14, wherein the carbazole group-containing polymer comprises a co-polymer of 9-phenyl-9H-carbazole-phenyl, poly(9-vinylcarbazole), or a blend thereof.

17. A method of forming a separator for a metal ion battery, the method comprising:
providing a microporus polymer sheet comprising polypropylene, polyethylene, a blend thereof, or layers thereof;
the microporous sheet having a first surface and an opposite facing second surface;
applying a slurry comprising a solvent and a carbazole group-containing polymer to the first surface of the microporus polymer sheet; and
removing the solvent to form the separator.

18. The method of claim 17, wherein the carbazole group-containing polymer comprises a co-polymer of 9-phenyl-9H-carbazole-phenyl, poly(9-vinylcarbazole), or a blend thereof.

19. The method of claim 17, wherein the slurry further comprises polyvinylidenedifluoride.

20. The method of claim 17, wherein the solvent comprises N-methylpyrrolidone.
